(19) United States
(12) Patent Application Publication
(10) Pub. No.: US 2007/0150716 A1
(43) Pub. Date: Jun. 28, 2007

(54) SYSTEM AND METHOD FOR SELECTING BOOT DEVICES FOR A COMPUTER VIA HOTKEYS

(75) Inventor: MING-LUNG LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,425

(22) Filed: Aug. 4, 2006

(30) Foreign Application Priority Data
Dec. 27, 2005 (CN) 200510121384.3

(51) Int. Cl. G06F 9/00

(52) U.S. Cl. 713/2

(57) ABSTRACT

A system for selecting boot devices via hotkeys is disclosed, the system includes: a setting module (301) for setting and saving one or more hotkeys for each bootable device in the computer (20) via a input device (10); a detecting module (302) for detecting whether any hotkeys are pressed during a power on self test (POST); a comparing module (303) for comparing the pressed hotkeys with the preset hotkeys, and determining a target boot device according to the comparison result; and a booting module (304) for booting up the computer (20) from the target boot device. A related method is also disclosed.

### 1. FIELD OF THE INVENTION

The present invention relates to computer booting technique, and particularly to a system and method for selecting boot devices for a computer via hotkeys.

### 2. DESCRIPTION OF RELATED ART

With the wide range of functionalities of computers, more and more manufactories has begin producing the computers. Before a manufacture computer leaves the factory, each computer should pass a factory acceptance test. Such tests, which involves a variety of tests on the computers includes functional testing that requires a change in the computers' boot order.

Usually, each newly manufactured computer is loaded with a basic input output system (BIOS). After a video system is installed and initialized, a monitor of the computer displays a prompt “Press F10 to enter SETUP” or a variation of it's equivalent while booting up the system. If a user properly responds to the prompt, i.e. by pressing the F10 key within a predetermined time after the appearance of the prompt, the computer will execute the BIOS program allowing the user to view and modify system configuration parameters. A setup of the boot order is also included in the BIOS setup program. In other words, the user can modify a setup of the boot order to change the computers' boot order by executing the BIOS program.

During the functional testing of the computer, the setup of the computers' boot order is changed many times; by using the process mentioned above, the functional testing will be very time consuming.

Therefore, what is needed is a system and method for selecting boot devices for a computer via hotkeys, by which the user can change the boot order of the computer conveniently.

### SUMMARY OF THE INVENTION

A system for selecting boot devices for a computer via hotkeys includes: a setting module for setting and saving one or more hotkeys for each bootable device in the computer via a input device; a detecting module for detecting whether any hotkeys are pressed during a power on self test (POST); a comparing module for comparing the pressed hotkeys with the preset hotkeys, and determining a target boot device according to the comparison result; and a booting module for booting up the computer from the target boot device.

A related method for selecting boot devices for a computer via hotkeys includes the steps of: powering on the computer; setting and saving one or more hotkeys for each bootable device in the computer via a input device; detecting whether any hotkeys are pressed during a power on self test (POST); comparing the pressed hotkeys with the preset hotkeys if any hotkeys are pressed, and determining a target boot device according to the comparison result; and booting up the computer from the target boot device.

Other advantages and novel features of the embodiments will be drawn from the following detailed description with reference to the attached drawings.

### BRIEF DESCRIPTION OF THE DRAWINGS

FIG. 1 is a schematic diagram of hardware configuration of a system for selecting boot devices for a computer via hotkeys in accordance with a preferred embodiment; and

FIG. 2 is a flowchart of a preferred method for selecting boot devices for a computer via hotkeys by utilizing the system of FIG. 1.

### DETAILED DESCRIPTION OF THE INVENTION

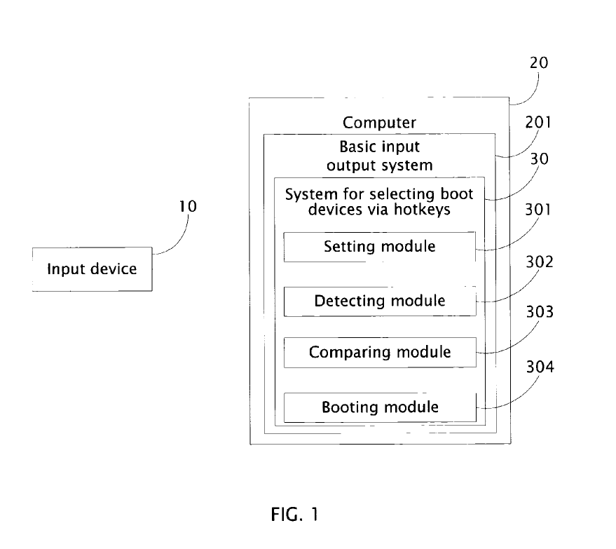

FIG. 1 is a schematic diagram of hardware configuration of a system for selecting boot devices for a computer via hotkeys (a.k.a. keyboard shortcut/shortcut keys) (hereinafter, “the system 30”) in accordance with a preferred embodiment. The system 30 is configured in a basic input output system (BIOS) 201 of a computer 20. The computer 20 is coupled to an input device 10, such as a keyboard that is used for setting one or more hotkeys for each bootable device of the computer 20. The hotkeys may be one or a combination of different input keys of the keyboard. The computer 20 may be a personal computer (PC), a notebook computer, a server, a workstation, or the like. The bootable device may be a hard disk (HD), a floppy device (FD), a compact disc read-only memory (CD-ROM), a universal serial bus (USB) port, or any other suitable device. The BIOS 201 is generally written in a read-only memory (ROM) chip included with the computer 20.

Typically, the system 30 includes a setting module 301, a detecting module 302, a comparing module 303 and, a booting module 304.

The setting module 301 is used for setting and saving one or more hotkeys for each bootable device in the computer 20 via the input device 10. For example, if the computer 20 is powered on and the system 30 is executed, a user may set a first hotkey “Ctrl” for a first target boot device HD to boot up the computer 20, set a second hotkey “Shift” for a second target boot device FD, and set a third hotkey “Alt” for a third target boot device CD-ROM. When the user reboots the computer 20 and presses any one of the three hotkeys, the computer 20 boots up from a corresponding target boot device. The hotkey may also be a combination of input keys of the input devices such as, for example, setting “F1” and “Alt,” to boot up the computer 20 with the USB port.

The detecting module 302 is used for detecting whether any hotkeys are pressed during a power on self test (POST). Usually, the computer 20 begins the POST procedure via the BIOS 201 right after being powered on, then loads the operating system from a default boot device according to a setting of the BIOS 201 after the POST procedure. However, if the setting module 301 has set one or more hotkeys, the detecting module 302 first detects whether any hotkeys are pressed during the POST procedure. If the hotkeys are pressed, the detecting module 302 sends the detection result to the comparing module 303, and the computer 20 boots up form a corresponding boot device. Otherwise, if no hotkeys are pressed, the computer 20 loads the operating system from the default boot device.

The comparing module 303 is used for comparing the hotkeys pressed with the preset hotkeys, and determining the corresponding target boot device according to the comparison result. For example, if the hotkey “Ctrl” is presses during the POST procedure, the detecting module 302 sends the detection result to the comparing module 303. The comparing module 303 compares the hotkey pressed “Ctrl” with the preset hotkeys, and determines the HD as the target boot device. The booting module 304 is used for booting up the computer 20 from the target boot device. According to the above example, the computer 20 boots up from the target boot device HD.

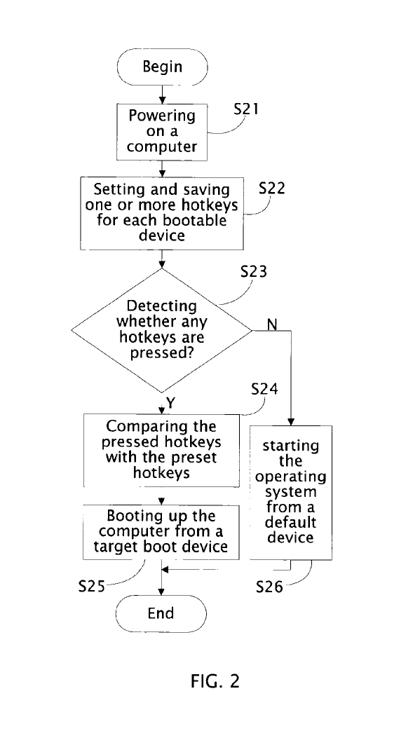

FIG. 2 is a flowchart of a preferred method for selecting boot devices for the computer 20 via hotkeys by utilizing the system of FIG. 1. In step S21, the computer 20 is powered on. In step S22, the setting module 301 sets and saves a unique hotkey for every bootable device in the computer 20 via the input device 10. In step S23, the detecting module 302 detects whether any hotkeys are pressed during the POST procedure. If the any hotkeys are pressed during the POST procedure, in step S24, the comparing module 303 compares the hotkeys pressed with the preset hotkeys, and determines the target boot device according to the comparison result. In step S25, the booting module 304 boots up the computer 20 from the target boot device.

Otherwise, if the detecting module 302 detects that no hotkeys are pressed in the step S23, the computer 20 loads the operating system from the default boot device according to the initialization of the BIOS 201.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for selecting boot devices for a computer via hotkeys, the system comprising:
a setting module for setting and saving one or more hotkeys for each bootable device in the computer via an input device;
a detecting module for detecting whether any hotkeys are pressed during a power on self test (POST);
a comparing module for comparing the pressed hotkeys with the preset hotkeys, and determining a target boot device according to the comparison result; and
a booting module for booting up the computer from the target boot device.

2. The system according to claim 1, wherein the input device is a keyboard.

3. The system according to claim 2, wherein the hotkeys are different function keys of the keyboard.

4. A method for selecting boot devices for a computer via hotkeys, the method comprising the steps of:
powering on the computer;
setting and saving one or more hotkeys for each bootable device in the computer via an input device;
detecting whether any hotkeys are pressed during a power on self test (POST);
comparing the pressed hotkeys with the preset hotkeys if any hotkeys are pressed, and determining a target boot device according to the comparison result; and
booting up the computer from the target boot device.

5. The method according to claim 4, further comprising the step of:
starting the operating system from a default boot device, if no hotkeys are pressed.
